(19) United States
(12) Patent Application Publication
(10) Pub. No.: US 2026/0216668 A1
(43) Pub. Date: Jul. 30, 2026

(54) WATER DISTILLATION MEMBRANES AND METHODS FOR USING THE SAME

(71) Applicant: CELLULOTECH INC., Victoria, British Columbia (CA)

(72) Inventor: Daniel SAMAIN, Toulouse (FR)

(21) Appl. No.: 19/148,597

(22) PCT Filed: Jan. 17, 2024
(86) PCT No.: PCT/IB2024/050456

§ 371 Date: Jul. 16, 2025

Related U.S. Application Data
(60) Provisional application No. 63/439,738, filed on Jan. 18, 2023.

(51) Int. Cl. B01D 71/10; B01D 61/36; B01D 69/02; C02F 1/44; C02F 103/08

(52) U.S. Cl. CPC B01D 71/10; B01D 61/364; B01D 61/366; B01D 69/02; C02F 1/447; B01D 2325/38; C02F 2103/08

(57) ABSTRACT

The disclosure relates to a membrane for water distillation, and systems containing the membrane. The membrane includes a porous material including cellulosic fibers with long chain fatty acids grafted to one or more hydroxyl groups of the cellulosic fibers. During distillation, a contact angle between water and the membrane is above 90 degrees.

### CROSS REFERENCE TO RELATED APPLICATION

This application claims priority to U.S. Provisional Application No. 63/349,738, filed Jan. 18, 2023, which is incorporated by reference herein.

### FIELD OF THE DISCLOSURE

The disclosure relates to water distillation membranes prepared by acylating hydroxylated porous materials with long chain fatty acids, and methods for desalting aqueous liquids with the membranes.

### BACKGROUND

A variety of filtration techniques are used across a wide range of industries, such as water desalination. Membrane separation technology, which is one of these techniques, offers an opportunity to provide efficient and sustainable production systems. There is, therefore, an important need for new membrane separation techniques.

For example, in the field of water desalination and purification, water scarcity is increasingly impacting developing and developed countries. Two methods that are currently widely used for such purposes are distillation and reverse osmosis. A drawback with the distillation method is that the process is energy intensive. A drawback with reverse osmosis method is that the process requires expensive membranes that are not bio-sourced. Another drawback with reverse osmosis is that the purified waters still contain significant amounts of dissolved salts which limits their application for drinking water and irrigation especially in the long term because of the build-up of salts residues. In addition, both processes are expensive: at a large scale, the end cost per cubic meter can be very similar for both methods.

Membrane water distillation is another method in this field. These membranes have to act as a 100% waterproof barrier for aqueous solutions and have to be, at the same time, highly permeable to gas in order to allow the vapor phase to pass efficiently through the membrane's pores. While different configurations of the membrane exist, the distillation process is mostly driven by a partial vapor pressure difference commonly triggered by a temperature difference. The membranes have to be as thin as possible so that the distance that water molecules need to travel in the gas phase could be as low as possible in order to achieve the highest possible efficiency for distillation. Because the temperature difference can be very small, and because there is no need to reach the water atmospheric pressure boiling point, the gas permeating process through the membranes requires very little energy. Some systems can function with small solar panels and offer a very low carbon footprint. Such technique can also be used to filter and decontaminate water from nonvolatile pollutants.

However, despite its advantages, at present, water membrane distillation has been applied in the industry only at a very small scale, mainly due to membrane fouling and the high cost of replacing them. Water membrane distillation requires then expensive pre-purification steps to eliminate impurities that could lower the membrane's efficiency and cause its early replacement. One additional problem with water membrane distillation is linked to the possibility of solid salt deposition due to water evaporation. Those solid salt deposits are fouling the membranes and are then severely hampering the distillation process. Therefore, it is required that their concentration be kept under the crystallization threshold thus generating large amounts of toxic brine (which is also observed with reverse osmosis). Distillation membranes are thus more suited for purification of low salty waters and their use for high salt concentration water such sea water is limited. Current water distillation membranes are usually made of microporous Teflon (polytetrafluoroethylene (PTFE)) membrane materials such as GoreTex® or polypropylene which are not bio-sourced, are expensive, and are mostly not recyclable.

Therefore, a need exists for a low-cost bio-sourced material that would offer the same barrier properties achieved by the current solutions but may reduce the need of pre-treatments as well as the cost of membranes and the overall distillation process. This would allow, among other things, desalination of water with a very low carbon footprint and low energy requirement at a large scale in a centralized or decentralized configuration. In addition, the membrane distillation process can also allow obtaining solid salts as a byproduct for use by the chemical industry.

Additionally, distillation membranes may be used in recovering elements such as gold, uranium, lithium, etc. Lithium has become of particular interest over the past few decades due to the advent of lithium-ion batteries as an important source of energy storage for automobile and electronic applications. Beside batteries, lithium also has applications in glass and ceramics, chemicals and pharmaceuticals, metallurgicals, and greases, for example. Accordingly, there remains a growing need for improved recovery processes and equipment for these applications.

The present inventors have discovered a process for preparing water distillation membranes that are cost-effective, efficient, and environmentally friendly.

### SUMMARY

The present disclosure relates to water distillation membranes that can be used for desalting aqueous liquids, methods for desalting aqueous water liquids using the membranes, and systems comprising the membranes.

In various embodiments, the disclosure relates to membranes for desalinating water, for purifying a liquid such as water, for recovering components from a liquid such as water, e.g. lithium, etc., the membranes comprising at least one porous hydroxylated substrate comprising one or more long chain fatty acids grafted to one or more hydroxyl groups of the substrate, wherein a contact angle θ between water and the substrate is greater than 90°, such as greater than about 120°, or greater than about 150°. The membranes may comprise more than one substrate, e.g. at least two substrates, at least three substrates, etc., wherein the substrates may be the same or different. The membranes and/or substrates may be hydrophobic, e.g. they may have a pressure threshold for water proofing of at least 5 cm of water height, or superhydrophobic with contact angles next to 180°. The hydroxylated substrates are solid, and may be chosen, for example, from porous flexible or rigid substrates. In various embodiments, the substrates comprise, consist essentially of, or consist of cellulosic materials or fibers, which may optionally be crosslinked. In various embodiments, the fatty acids may be chosen from C6-C50 fatty acids, preferably C8-C50 fatty acids, more preferably C14-C50 fatty acids, most preferably C18-C50 fatty acids. By way of non-limiting example, the fatty acids may be chosen from behenic acid, palmitic acid, stearic acid or a combination of two or more thereof.

In further embodiments, the disclosure relates to methods for desalting aqueous liquids, the methods comprising evaporating the liquid through a membrane according to the disclosure. The methods may, for example, be methods for desalinating water, methods for purifying a liquid such as water, methods for recovering components from a liquid such as water, e.g. for recovering lithium from water solutions.

### BRIEF DESCRIPTION OF THE FIGURES

FIG. 1A is an image depicting the effect of evaporating salted water on front side of a 4-ply tissue paper made of cellulose grafted with long chain fatty acids

FIG. 1B is another image depicting the effect of evaporating salted water on reverse side of the 4-ply tissue paper made of cellulose grafted with long chain fatty acid.

FIG. 2 is an image of a distilled water droplet compared with a saturated saltwater droplet. The contact angle is observed to be higher with saturated saltwater droplet indicating that the hydrophobic efficiency of the membrane is increasing with increasing salt concentration. This is due to the salting out effect of the dissolved salts and explains notably why it is possible to completely evaporate water from salt water and leave behind only solid salts without any leakage through the membrane.

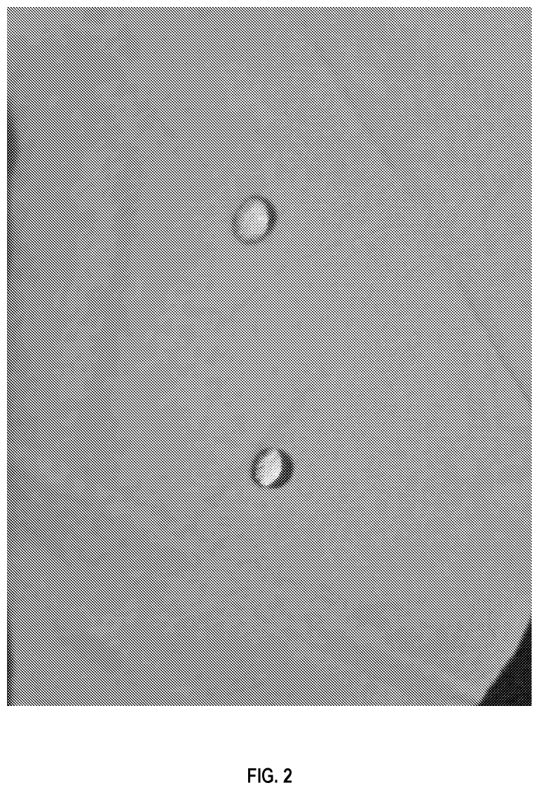

### DETAILED DESCRIPTION

The disclosure relates to water distillation membranes prepared by acylating porous hydroxylated solid substrates with long chain fatty acids, methods for desalting aqueous liquids with the membranes, as well as desalting systems comprising the membranes.

In various embodiments, the hydroxylated solid substrates that can be used include solid materials which comprise reactive hydroxyl groups (—OH). The hydroxylated material is preferably as porous as possible to allow the maximum gas flow rate through the membrane and the material may itself comprise reactive hydroxyl groups or may be treated to comprise reactive hydroxyl groups. The solid material can be rigid or can be flexible and capable of extending at least in part in a plane. For example, a porous solid material with reactive hydroxyl groups can be a cellulosic material, such as paper, tissue paper, cardboard, fabric, etc.

As non-limiting examples, the hydroxylated solid substrate may be totally or primarily cellulosic, e.g. paper, cardboard, or any material consisting primarily of or consisting totally of cellulose materials or fibers.

In some embodiments, the hydroxylated substrate comprises cellulosic material that is partially or totally crosslinked. By way of example, the substrate may comprise one or more cellulosic sheets, some or all of which are formed from crosslinked cellulose fibers, linked together by hydrogen bonds and by covalent bonds formed with at least one group of crosslinking atoms. A useful but non-limiting crosslinking atom group is a derivative of 1-chloro-2,3-epoxypropane. Cross-linked cellulosic substrates may provide additional advantages for membrane distillation, such as providing grafted long chain fatty acids with lower rotational mobility. When the rotational mobility reaches the lowest state, the contact angles are observed to be higher and more stable overtime. This can, for example, be advantageous to maintain long-term barrier against high concentration salt water.

The acylation of the hydroxylated solid substrate with long-chain fatty acids makes the substrate substantially impermeable to liquid aqueous salty solutions while non affecting its permeability to gas. In various embodiments, the fatty acids that can be used as acylating agents are chosen from fatty acids having from 6 to 50 carbon atoms, for example from 8 to 50 carbon atoms, from 14 to 50 carbon atoms, or from 18 to 50 carbon atoms, such as from 6 to 40 carbon atoms, from 8 to 40 carbon atoms, from 14 to 40 carbon atoms, or from 18 to 40 carbon atoms, or from 12 to 30 carbon atoms, from 16 to 28 carbon atoms, or from 18 to 24 carbon atoms. For example, the fatty acids may have a C6, C7, C8, C9, C10, C11, C12, C13, C14, C15, C16, C17, C18, C19, C20, C21, C22, C23, C24, C25, C26, C27, C28, C29, C30, C31, C32, C33, C34, C35, C36, C37, C38, C39, C40, C41, C42, C43, C44, C45, C46, C47, C48, C49, or C50 hydrocarbon chain, or may have a hydrocarbon chain having a range of carbon atoms using any of the foregoing as upper and lower limits. By way of non-limiting example only, caprylic acid, capric acid, lauric acid, myristic acid, palmitic acid, stearic acid, arachidic acid, behenic acid, lignoceric acid, cerotic acid, linoleic acid, oleic acid, palmitoleic acid, arachidonic acid, docosahexaenoic acid, or mixtures of two or more thereof may be chosen. In one embodiment, the fatty acid comprises, consists essentially of, or consists of behenic acid, palmitic acid, stearic acid, or a combination of two or more thereof. In certain embodiments, the fatty acids that are used comprise, consist essentially of, or consist of fatty acids that are plant- and/or animal-based.

In the acylation reaction, a long-chain fatty acid reagent reacts with the reactive hydroxyl groups of the solid substrate and forms an ester group between the substrate and the hydrocarbon chain of the fatty acid, according to the following reaction:

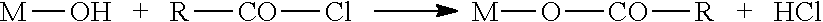

wherein:
   M—OH=hydroxylated solid substrate;
   R=hydrocarbon chain, e.g. C5-C49; and
   R—CO—Cl=long chain fatty acid chloride.

The acylation process may be carried out by any known means. For example, the processes described in WO 2022/033698, WO 2022/117926, or WO 2023/233202, which are incorporated by reference herein, may be used.

By way of example only, the porous hydroxylated solid substrate may be treated with the fatty acid chloride by contacting the substrate with the fatty acid chloride, applying the fatty acid chloride to the substrate, distributing the fatty acid chloride on the substrate, etc. The hydroxylated solid substrate may be treated with the fatty acid chloride by any means, such as with a distributing device having an applicator surface capable of depositing the fatty acid chloride at least on the surface of, and optionally into a thickness of, the substrate. The fatty acid chloride may be in a composition comprising additional components such as solvents, additives, adjuvants, etc., or may be the sole component that the substrate is treated with during the acylation process. Once the porous hydroxylated solid substrate is treated with the fatty acid chloride, the treated substrate is heated at a temperature, called the acylation temperature, lower than the vaporization temperature of at least one fatty acid chloride on the substrate, thereby acylating the hydroxylated substrate by reaction of the fatty acid chloride in the gaseous state with at least one of the reactive hydroxyl groups of the substrate.

The hydroxylated solid substrate may be grafted with the fatty acid at a rate ranging from about 0.01% w/w to about 1% w/w.

Specific heating mechanism such as, but not limited to, air oven can be used so that the fatty acid chloride reagent is in equilibrium between its liquid and gas state. The acylation temperature may vary, but may in some embodiments range from about 140° C. to about 300° C.

The treated substrate may be subjected to the acylation temperature for any period of time as needed for the process to proceed. For example, the treated substrate may be heated for a period of time ranging from about 0.1 second to a few seconds.

Membranes comprising substrates according to the disclosure have surprising and advantageous benefits for use in distillation applications. For example, the substrates are highly hydrophobic, even superhydrophobic in some embodiments, yet remain permeable to gases, including water vapor. In addition, substrates according to the disclosure have a contact angle θ with water greater than 90°, for example greater than or equal to 100°, greater than or equal to 110°, greater than or equal to 120°, greater than or equal to 130°, greater than or equal to 140°, or greater than or equal to 150°, and can maintain the durability of the contact angle. Moreover, the contact angle θ increases with the carbon chain length of the fatty acids. Thus, the increased hydrophobicity and increased contact angle @ allow to make membranes with higher porosity according to the disclosure ideal for filtration applications such as water desalination, water purification, lithium recovery, etc.

In addition, substrates according to the disclosure that are cellulose-based can maintain their recyclability and compostability, unlike typical membranes, and are extremely cost-effective. Cellulose-based membranes according to the disclosure have the additional advantage of ease of recovery of solids collected during the filtration process, in that the cellulose material can be burned without releasing harmful materials into the environment.

Further, because membranes according to the disclosure comprise a material with high gas permeability but minimal or no capillary intake, they permit water vapor driven by a partial vapor pressure difference to permeate. Such the partial vapor pressure difference can be small and therefore may require very little energy input, and therefore systems comprising membranes according to the disclosure may, for example, be solar powered such as with a photovoltaic panel or a solar thermal collector.

Membranes and systems according to the disclosure therefore provide opportunities for desalting applications that are more efficient than traditional filtration systems, lower in cost than traditional filtration systems, more environmentally friendly than traditional filtration systems, and that can be used on either a small or large scale.

In addition, because they can provide distilled water at low cost almost anywhere, the membranes and systems can be used for electrolysis of water, especially with acidic systems that need to prevent the fouling of catalysts.

In one particularly preferred embodiment, methods according to the disclosure are methods for desalinating water using membranes or systems described herein. In another preferred embodiment, methods according to the disclosure are methods for purifying a liquid, e.g. water, using membranes or systems described herein. In yet another preferred embodiment, methods according to the disclosure are methods for recovering components, e.g. lithium, from a liquid such as water using membranes or systems described herein.

Having described the many embodiments of the present invention in detail, it will be apparent that modifications and variations are possible without departing from the scope of the disclosure defined in the appended claims. Furthermore, it should be appreciated that the Example, while illustrating an embodiment of the disclosure, is not to be taken as limiting the various aspects described herein. It is to be understood that all definitions herein are provided for the present disclosure only.

As used herein, the terms “comprising,” “having,” and “including” (or “comprise,” “have,” and “include”) are used in their open, non-limiting sense.

In this application, the use of the singular includes the plural unless specifically stated otherwise. The singular forms “a,” “an,” “the,” and “at least one” are understood to encompass the plural as well as the singular unless the context clearly dictates otherwise. The expression “one or more” and “at least one” are interchangeable and expressly include individual components as well as mixtures/combinations.

The term “and/or” should be understood to include both the conjunctive and the disjunctive.

As used herein, the phrases “and mixtures thereof,” “and a mixture thereof,” “and combinations thereof,” “and a combination thereof,” “or mixtures thereof,” “or a mixture thereof,” “or combinations thereof,” and “or a combination thereof,” are used interchangeably to denote that the listing of components immediately preceding the phrase, such as “A, B, C, D, or mixtures thereof” signify that the component(s) may be chosen from A, from B, from C, from D, from A+B, from A+B+C, from A+D, from A+C+D, etc., without limitation on the variations thereof. Thus, the components may be used individually or in any combination thereof.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

All ranges and amounts given herein are intended to include sub-ranges and amounts using any disclosed point as an end point, and all endpoints are intended to be included unless expressly stated otherwise. Thus, a range of “1% to 10%, such as 2% to 8%, such as 3% to 5%,” is intended to encompass ranges of “1% to 8%,” “1% to 5%,” “2% to 10%,” and so on. All numbers, amounts, ranges, etc., are intended to be modified by the term “about,” whether or not expressly stated, unless expressly stated otherwise. Similarly, a range given of “about 1% to 10%” is intended to have the term “about” modifying both the 1% and the 10% endpoints. The term “about” is used herein to indicate a difference of up to +/−10% from the stated number, such as +/−9%, +/−8%, +/−7%, +/−6%, +/−5%, +/−4%, +/−3%, +/−2%, or +/−1%. Likewise, all endpoints of ranges are understood to be individually disclosed, such that, for example, a range of 1:2 to 2:1 is understood to disclose a ratio of both 1:2 and 2:1.

As used herein, if a component is described as being present “in an amount up to” a certain amount, it is intended that such component is, in fact, present in the composition, i.e. is present in an amount greater than 0%.

All amounts and ratios herein are given based upon the total weight of the composition, unless otherwise indicated. Unless otherwise indicated, all percentages herein are by weight of active material.

As used herein, the term “membrane” is intended to refer to a single substrate or to a plurality of substrates, typically but not necessarily in physical contact with one another. For example, a single layer of hydroxylated cellulosic material treated with a fatty acid according to the disclosure may comprise a membrane, or a membrane may comprise multiple layers of hydroxylated cellulosic material treated with a fatty acid according to the disclosure, e.g. a two-ply, three-ply, etc. paper. It should be understood, however, that if a membrane comprises more than one substrate, the substrates may be the same or may be different, and it is also possible that a membrane comprises one or more substrates treated with a fatty acid according to the disclosure and one or more substrates not treated with a fatty acid according to the disclosure.

As used herein, the term “reactive hydroxyl groups (—OH)” means hydroxyl groups that are accessible and capable of reacting with a long-chain fatty acid in the processes described herein in the gaseous state. The hydroxyl groups may be on the surface of the material, or may be within the thickness of the material, and the location thereof should not be limited unless expressly stated.

As used herein, the term “hydrophobic” and variations thereof means that a pressure needed to get liquid through the capillary is at least about 5 cm of water height, calculated by Jurin's law: P=−2(γ)*cos (θ)/d, where P represents pressure for driving water to filtrate the membrane in the capillary action, γ represents a surface tension of a liquid filtrating through a membrane, θ represents an acute contact angle between a liquid droplet and the membrane, and d represents the pore size of the membrane.

From Jurin's law, it is easy to deduce that a higher contact angle allows for a larger pore diameter to obtain the same threshold pressure.

The term “superhydrophobic” refers to contact angles next to 180°. With those high contact angle values, water droplets no longer bind to the substrate surface area but, on the contrary, roll freely upon it.

The example that follows serves to illustrate an embodiment of the present disclosure without, however, being limiting in nature. It will be apparent to those skilled in the art that various modifications and variations can be made without departing from the spirit or scope of the invention.

### EXAMPLES

The following Examples are intended to be non-limiting and explanatory in nature only.

### Example 1

A 20 cm×20 cm membrane comprising four layered substrates made of porous cellulosic fibres (light-weight tissue paper) was treated by applying stearic acid chloride thereto at a rate of 0.1% w/w. After a few seconds at 180° C. in an air circulating oven the acylation process was complete, and the substrate was allowed to cool at room temperature, providing a hydrophobic cellulose fibre membrane.

Once the substrate was back at room temperature, a pocket was formed, salt water was added, and the pocket was closed. The membrane loaded with salt water was placed into an 80° C. air circulating oven until all water had evaporated through the membrane. The membrane was removed from the oven and the pocket opened.

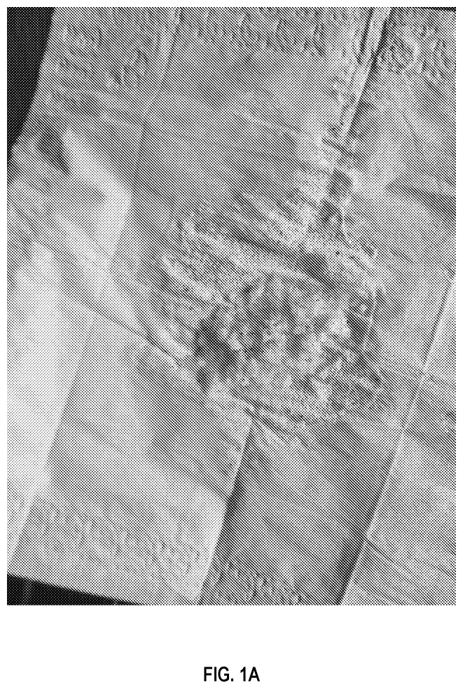

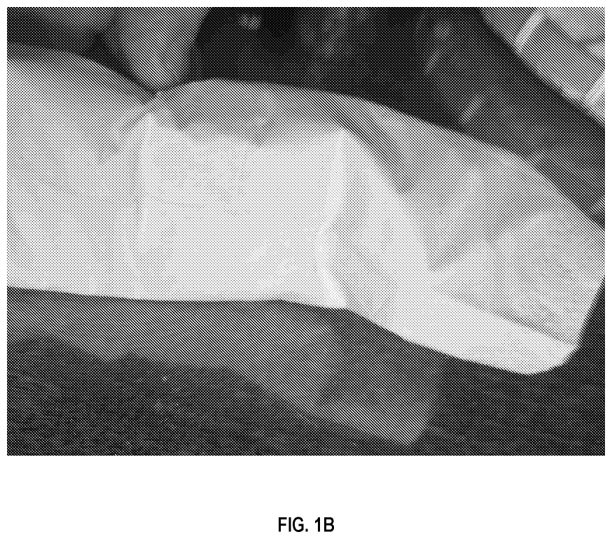

FIG. 1A shows the membrane after the pocket was opened. As can be seen, once the water had evaporated, the salt remained. In addition, it was observed that other than the substrate that was in contact with the water (substrate 1, FIG. 1A), the remaining three substrates (substrates 2-4) of the membrane were completely intact. This is seen in in FIG. 1B, which shows substrate 4 at the conclusion of the experiment.

This Example therefore demonstrates that the treated cellulose membranes can be used to effectively distil saltwater, where the membrane permitted permeation of the water vapor but captured the salt crystals. The fact that the three remaining substrates were intact confirms this.

### Example 2

A 20 cm×20 cm membrane comprising four layered substrates made of porous cellulosic fibres similar to that used in Example 1 was treated in the same manner as detailed in Example 1 to provide a hydrophobic cellulose fibre membrane.

An assembly was prepared to study the ability of the treated cellulose fibre membrane to distill salt water, as follows. Two open-top commercial stackable plastic boxes (10 cm×10 cm×5 cm high) were placed on top of each other, leaving a 2 cm reservoir in the lower box between the two boxes. Fifty (50) 5 mm diameter holes were drilled in the bottom of the upper box to permit gaseous communication between the two boxes. The drilled bottom of the upper box was covered with a 10 cm×10 cm plastic screen support having 1 mm pores. The hydrophobic cellulose fibre membrane was then placed on top of the plastic screen, creating a pool within the upper box with the extra surface of the membrane going up each side of the box. The pool was filled with salted (35 g/L) water until it was 2 cm deep.

The assembly was then fitted with 2 thermometer probes, the first one in contact with the salt water in the upper box and the second one in contact with the bottom of the lower box. The assembly was then placed upon a cold pad and under an infrared lamp. The cold pad was meant to maintain the content of the lower box at a temperature near 0° C., while the infrared lamp was meant to warm up the salt water compartment in the upper box above room temperature.

After 30 minutes, water was observed to be condensing in the lower box, meaning that the salt water from the pool in the upper box was, upon heating, being distilled into the cooler lower box. It was also noted that the system had thermally equilibrated, with the temperature in the lower box around 5° C. and the temperature in the upper box around 70° C. After 4 hours, the two boxes were disconnected and the volume of water that had condensed in the lower box was measured to be 50 mL.

The condensate was then evaluated to determine salt content. Mouth tasting of the condensed water indicated no salty taste, and subsequent evaporation of the condensed water showed only traces of solid remains. This Example therefore demonstrates that the treated cellulose fibre membranes and systems including the membranes can be used to effectively distill salt water at temperatures below the boiling point of water.

The above Examples demonstrate that methods of desalinating water using membranes according to the disclosure are advantageous compared to known methods, such as reverse osmosis which does not collect the salt but rather returns it to the ocean.

1. A method for desalting an aqueous solution, the method comprising:
evaporating the water in the solution through a membrane comprising:
at least one hydroxylated porous substrate comprising one or more long chain fatty acids grafted to one or more hydroxyl groups of the substrate,
wherein a contact angle θ between water and the substrate is greater than 90°.

2. The method of claim 1 wherein the hydroxylated substrate is flexible or rigid.

3. The method of claim 1, wherein the hydroxylated substrate comprises cellulose.

4. The method of claim 3, wherein the cellulose is cross-linked.

5. The method of claim 1, wherein the hydroxylated substrate consists of cellulose.

6. The method of claim 1, wherein the long-chain fatty acids are chosen from C6-C50 fatty acids.

7. The method of claim 1, wherein the long-chain fatty acids are chosen from behenic acid, palmitic acid, stearic acid, thereof, or a combination of two or more thereof.

8. The method of claim 1, wherein the contact angle θ is greater than or equal to 100°.

9. A method for desalinating or purifying water, the method comprising:
distilling the water through a membrane comprising: at least one hydroxylated substrate comprising:
one or more long chain fatty acids grafted to one or more hydroxyl groups of the substrate, wherein a contact angle θ between water and the substrate is greater than 90°.

10. The method of claim 9, wherein the hydroxylated substrate is porous.

11. The method of claim 9, wherein a pressure threshold for water filtration in the membrane is at least 5 cm of water height.

12. A system for distilling a liquid, the system comprising:
at least one membrane comprising:
at least one hydroxylated porous substrate comprising one or more long chain fatty acids grafted to one or more hydroxyl groups of the substrate,
wherein a contact angle θ between water and the substrate is greater than 90°.

13. The system of claim 12, wherein the hydroxylated substrate comprises cellulose.

14. The system of claim 13, wherein the cellulose is cross-linked.

15. The system of claim 12, wherein the hydroxylated substrate consists of cellulose.

16. The system of claim 12, wherein the long-chain fatty acids are chosen from C6-C50 fatty acids.

17. The system of claim 12, wherein the long-chain fatty acids are chosen from behenic acid, palmitic acid, stearic acid, thereof, or a combination of two or more thereof.

18. The system of claim 12, wherein the contact angle θ is greater than or equal to 100°.

19. The system of claim 12, which is a system for desalinating water.

20. The method of claim 1, wherein a pressure threshold for water filtration in the membrane is at least 5 cm of water height.
